(19) United States
(12) Patent Application Publication
(10) Pub. No.: US 2025/0094732 A1
(43) Pub. Date: Mar. 20, 2025

(54) MULTIPLE SUMMARY SELECTION SYSTEM

(71) Applicant: Oracle International Corporation, Redwood Shores, CA (US)

(72) Inventors: Ankit Kumar Aggarwal, Mumbai (IN); Haad Khan, Austin, TX (US); Liyu Gong, Lexington, KY (US); Jie Xing, Redmond, WA (US); Pramir Sarkar, Bangalore (IN)

(73) Assignee: Oracle International Corporation, Redwood Shores, CA (US)

(21) Appl. No.: 18/663,988

(22) Filed: May 14, 2024

(30) Foreign Application Priority Data
Sep. 15, 2023 (IN) 202341062220
Sep. 15, 2023 (IN) 202341062254

(51) Int. Cl. G06F 40/40

(52) U.S. Cl. CPC G06F 40/40

(57) ABSTRACT

A summary generation and summary selection system is disclosed that is capable of automatically evaluating multiple summaries generated for content and selecting a single summary that is deemed to be the “best” among the multiple generated summaries. The system includes capabilities to use multiple different selection techniques to select the best summary from multiple generated summaries. A first selection technique involves identifying entities and entity relationships from the content to be summarized and selecting a summary from multiple summaries generated for the content based on the entities and entity relationships identified in the content. A second selection technique involves determining a set of questions that are answered by each summary. The technique then selects a summary based upon the set of questions answered by each summary. The system then outputs the selected summary as the summary for the content.

### CROSS-REFERENCES TO RELATED APPLICATIONS

The present application is a non-provisional application of and claims the benefit and priority to India Provisional Application No. 202341062254, filed Sep. 15, 2023, entitled “Enhanced AI-Based Hospital Course Summarization System,” and India Provisional Application No. 202341062220, filed Sep. 15, 2023, entitled “Harmonizing Queries and Summaries: The Zen of Informed Selection,” the entire contents of which are incorporated herein by reference for all purposes.

### FIELD

The present disclosure relates generally to evaluating multiple summaries generated for content to be summarized and selecting a single summary from the multiple summaries. More specifically, multiple summary selection techniques are disclosed, each technique configured to select a particular summary from the multiple generated summaries by evaluating the multiple summaries using criteria specific to that technique.

### BACKGROUND

In today's information-rich age, the volume of data that is generated is extremely large. The success or failure of a user (e.g., a human user, a company, etc.) of that data many times depends on their ability to comprehend the data quickly. In many use cases, given the timeframe available for comprehending the data, it is impossible for the user to read or review all the original data-instead the user has to rely on a summary of the data. Summarization is a process that generates a summary for some data, where the length or size of the summary is far less than that of the original data being summarized. A summary is typically a shortened or condensed version of much larger data content that retains the main themes or concepts or ideas described in the larger content. A good summary is one that properly and accurately represents the content being summarized.

In the past, summaries were manually generated. This took a lot of effort and time. With the rise of artificial intelligence techniques, and particularly with the rising popularity of Large Language Models (LLMs), LLMs are used to generate summaries for various types of content, such as documents, webpages, news articles, research papers, etc. This has made it substantially easier to generate summaries very quickly.

Various types of models, including language models (e.g. BERT) and LLMs (e.g., GPT-4) can be used to create summaries. For example, multiple summaries can be generated for the same content to be summarized using different models. Even for the same model, the model may generate different summaries for the same content based upon changes to the configuration of the models, types of prompts provided to the model, the summarization strategy used (e.g., chain of thought prompting technique, a multi-hop question answer evaluation), the input parameters (setup) for the model, the temperature setting used for the model to control the randomness, and the like. As a result, for the same content to be summarized, multiple summaries can be created that are different in terms of content and accuracy. It is a non-trivial and technically challenging task to determine which summary, from the multiple generated summaries, is the “best” one.

### BRIEF SUMMARY

The present disclosure relates generally to evaluating multiple summaries generated for content to be summarized and selecting a single summary from the multiple summaries. More specifically, multiple summary selection techniques are disclosed, each technique configured to select a particular summary from the multiple generated summaries by evaluating the multiple summaries using criteria specific to that technique.

In certain embodiments, a summary generation and summary selection system is disclosed that is capable of automatically evaluating multiple summaries generated for content and selecting a single summary that is deemed to be the “best” among the multiple generated summaries. The system includes capabilities to use multiple different selection techniques to select the best summary from multiple generated summaries. A first selection technique involves identifying entities and entity relationships from the content to be summarized and selecting a summary from multiple summaries generated for the content based on the entities and entity relationships identified in the content.

In certain examples, the first selection technique involves identifying a set of prioritized entities present in content to be summarized. A prioritized entity is an entity that is deemed to be an essential part of a good summary. The prioritized entities correspond to one or more prioritized entity categories identified in reference information stored by the system. The technique then involves identifying a set of prioritized entity relationships present in the content to be summarized. The prioritized entity relationships correspond to one or more prioritized entity relationship categories identified in reference information stored by the system. The technique then involves selecting, from multiple summaries generated for the content to be summarized, a summary that includes each entity in the set of prioritized entities and each entity relationship in the set of prioritized entity relationships that was present in the content to be summarized. The technique then involves providing the selected summary as a summary for the content to be summarized.

In certain examples, the second selection technique for selecting a summary from multiple summaries is disclosed. The second selection technique involves using a questions-based approach to select a summary from multiple summaries generated for content to be summarized. This technique involves obtaining multiple summaries for content to be summarized and determining a set of questions that are answered by each summary. The technique then involves selecting a summary from the multiple summaries based upon a set of prioritized questions that are answered by each summary in the multiple summaries. The technique then involves providing the selected summary as a summary for the content to be summarized.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided therein.

### BRIEF DESCRIPTION OF THE DRAWINGS

FIG. 1 depicts an example computing environment 100 of a summary generation and summary selection system that includes capabilities for automatically evaluating multiple summaries generated for content and selecting a single summary from among the multiple generated summaries, according to certain embodiments.

FIG. 2 depicts a simplified flowchart depicting the processing performed by the system 102 shown in FIG. 1, according to certain embodiments.

FIG. 3 is a simplified block diagram of the information blocks and functionality provided by the technique-1 summary selection subsystem shown in FIG. 1 for selecting a summary from among multiple generated summaries, according to certain embodiments.

FIG. 4 is a simplified flowchart depicting the processing performed by the subsystem 118 for selecting a particular summary for the content to be summarized using entity-entity relationship analysis and clustering, according to certain embodiments.

FIG. 5 depicts a simplified flowchart depicting the processing performed by subsystem 118 for generating clusters of summaries, according to certain embodiments.

FIG. 6 depicts a simplified flowchart depicting the processing performed by subsystem 118 for selecting a summary from one or more summaries that are part of a selected cluster of summaries, according to certain embodiments.

FIG. 7 depicts a simplified flowchart depicting the processing performed by the subsystem 118 for selecting a summary from the multiple summaries, according to certain embodiments.

FIG. 8 is a simplified block diagram of the information used and the functionality provided by the technique-2 summary selection subsystem shown in FIG. 1 for selecting a summary from among multiple generated summaries, according to certain embodiments.

FIG. 9A depicts a simplified flowchart depicting the processing performed by the system shown in FIG. 1 for selecting a summary from among multiple summaries, according to certain embodiments.

FIG. 9B depicts a simplified flowchart depicting the processing performed by the technique-2 summary selection subsystem shown in FIG. 1 to select a summary, according to certain embodiments.

FIG. 9C depicts a simplified flowchart depicting the processing performed by the technique-2 summary selection subsystem shown in FIG. 1 to select a summary, according to certain embodiments.

FIG. 10A depicts a simplified flowchart depicting the processing performed by the system 102 shown in FIG. 1 for selecting a summary from among multiple summaries, according to certain embodiments.

FIG. 10B depicts a simplified flowchart depicting the processing performed by the technique-2 summary selection subsystem shown in FIG. 1 to select a summary, according to certain embodiments.

FIG. 10C depicts a simplified flowchart 1000 depicting the processing performed by the technique-2 summary selection subsystem 120 shown in FIG. 1 to select a summary, according to certain embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to evaluating multiple summaries generated for content to be summarized and selecting a single summary from the multiple summaries. More specifically, multiple summary selection techniques are disclosed, each technique configured to select a particular summary from the multiple generated summaries by evaluating the multiple summaries using criteria specific to that technique. Each summary selection technique evaluates the multiple summaries using selection criteria for that technique and selects a summary that is the “best” based upon the technique's selection criteria. Automated and computer-implemented summary selection techniques are described that select summaries of high quality from among multiple generated summaries.

As described in the Background section, while the use of LLMs has made it easier to generate summaries for some content, because the content of the generated summaries can change due to various parameters, it is very difficult to identify which summary is the “best” summary for the content. Thus, also what is “best” for one user or use case can be different for another user or use case. Conventional approaches for evaluating multiple summaries to identify the “best” single summary involve a lot of manual labor—manually inspecting the summaries to determine the “best” summary. This again is very time consuming, labor intensive, and prone to errors.

The present disclosure addresses the several deficiencies described above. A summary generation and summary selection system is described that is capable of automatically evaluating multiple summaries generated for some content and selecting a single summary (also referred to herein as a “completion”) that is deemed to be the “best” among the multiple generated summaries for the content. Since what is “best” can vary from one user to another and from one use case to another, the system can be configured to use multiple different selection techniques to select the best summary from multiple generated summaries. For example, a summary selection system may be configured to use a first selection technique that uses first criteria to select one summary from multiple summaries generated for some content. The same summary generation and summary selection system may be configured to use a second selection technique that uses second criteria to select one summary from multiple summaries generated for some content, where the second technique is different from the first technique. Various other such techniques may be used by the summary selection system.

In certain implementations, the first summary selection technique involves extracting key elements such as entities and entity relationships from the content to be summarized. The technique then involves selecting a summary from multiple summaries generated for the content based on the identified entities and entity relationships. The entities and entity relationships are identified using an LLM model and an entity relationship extraction prompt, which represents a small number of examples (e.g., 1-5) that are provided to the LLM to identify entities and entity relationships from the content to be summarized. The technique then selects a particular summary from the multiple summaries based on the entities and entity relationships that were identified in the content to be summarized. In certain examples, a particular summary is selected by analyzing summaries within a selected cluster of summaries using selection criteria. Based on the analysis, the technique identifies a particular summary that is deemed to be the “best” among the multiple generated summaries for the content to be summarized. In certain examples, the selected summary includes all the prioritized entities and all the prioritized entity relationships that were identified in the content to be summarized.

As previously described, in certain instances, the summary generation and summary selection system may be configured to use a second selection technique that uses second criteria to select a summary from multiple summaries generated for content to be summarized, where the second technique is different from the first technique described above. In certain embodiments, the second summary selection technique uses a questions-based approach to select a summary from multiple summaries generated for content to be summarized. This technique involves determining a set of prioritized questions (also referred to herein as must-answer questions) identified in a reference set of questions that are answered by each summary. A prioritized question is defined as an essential question that is to be answered by a summary. The technique then selects a summary based upon the set of prioritized questions answered by each of the summaries and provides the selected summary as a summary for the content to be summarized.

In certain embodiments, the summary generation and summary selection system can be configured to generate multiple different hospital discharge summaries for a hospital note associated with a patient. A hospital note may include, for instance, admission notes, procedure notes, daily progress notes and so on related to a patient that describe the patient's symptoms, ailment, treatment provided, and progress during the patient's stay at the hospital. The hospital discharge summary represents a shortened or condensed version of the hospital note that properly and accurately represents the hospital note being summarized. The system can be configured to apply different summary selection techniques as described above to automatically evaluate the multiple hospital discharge summaries generated for the hospital note and select a single hospital discharge summary that is deemed to be the “best” among the multiple generated summaries for the hospital note.

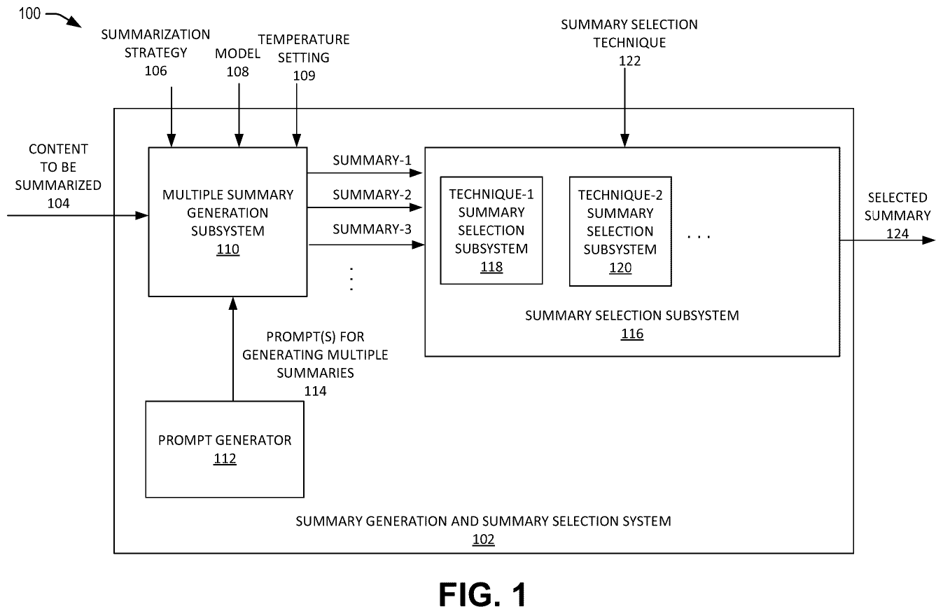

Referring now to the drawings, FIG. 1 depicts an example computing environment 100 of a summary generation and summary selection system 102 that includes capabilities for automatically evaluating multiple summaries generated for content and selecting a single summary from among the multiple generated summaries, according to certain embodiments. The summary generation and summary selection system 102 may be implemented using one or more computing systems. For example, the computing systems may execute computer-readable instructions (e.g., code, program) to implement the system 102. As depicted in FIG. 1, the system 102 includes various computing systems including a multiple summary generation subsystem 110, a prompt generator 112 and a summary selection subsystem 116. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device).

The system 102 may be implemented using various different configurations. In certain embodiments, the system 102 may represent a computing system of an entity (for e.g., an organization, an enterprise, or an individual) that provides multiple summary generation and summary selection functionality to its users. In other embodiments, the system 102 may be implemented on one or more servers of a cloud provider network and its multiple summary generation and summary selection services may be provided to subscribers of cloud services on a subscription basis. The functionality to provide multiple summary generation and summary selection, as described in this disclosure, may be offered as part of the service. A customer can subscribe to the service to generate multiple summaries for content to be summarized and select a single summary from the multiple summaries for its users. As part of generating the multiple summaries and selecting a summary from the multiple summaries, in certain examples, the service may also display the selected summary via a UI of a computing device of the requesting subscriber as described in this disclosure.

Computing environment 100 depicted in FIG. 1 is merely an example and is not intended to unduly limit the scope of claimed embodiments. One of ordinary skill in the art would recognize many possible variations, alternatives, and modifications. For example, in some implementations, the system can be implemented using more or fewer subsystems than those shown in FIG. 1, may combine two or more subsystems, or may have a different configuration or arrangement of subsystems.

The summary generation and summary selection system 102 may be configured to generate summaries for various types of content, such as documents, webpages, news articles, research papers, hospital notes and so on. The system 102 may receive the content to be summarized in various ways. For instance, in one approach, the system 102 may receive the content to be summarized via an application of a user device. A user may interact with the system 102 using a user device that is communicatively coupled to the system 102, possibly via one or more communication networks. The user device may be of various types, including but not limited to, a mobile phone, a tablet, a desktop computer, and the like. The user may use the application to input the content to be summarized by the system 102. In other approaches, the content to be summarized may be provided via a cloud service to the system 102. In certain examples, the content to be summarized 104 represents a hospital note related to a patient's admission to a hospital. The system 102 receives the hospital note and generates multiple hospital discharge summaries for the hospital note. The system then evaluates the multiple summaries and selects a single summary (also referred to herein as a “completion”) that is deemed to be the “best” among the multiple generated summaries for the content.

In a certain implementation, the multiple summaries are generated by a multiple summary generation subsystem 110 within the system 102. The subsystem 110 may utilize various types of models, including language models (e.g. BERT) and large language models (LLMs) such as GPT-4 to create multiple summaries simultaneously for the content to be summarized. The models can be used to produce multiple, varied outputs (summaries) by altering the set up (a set of input parameters) provided to the system 102. The set of input parameters may include, for instance, the configuration (type) of the model 108 used to create the summaries, the prompts 114 for generating the multiple summaries, the summarization strategy 106 (e.g., chain of thought prompting technique, a multi-hop question answer evaluation) used by the model to create the summaries, the temperature setting 109 used by the model to control the randomness of the created summaries, and so on. Additional details of the input parameters used by the system 102 to generate multiple summaries is discussed in detail below.

The multiple summaries (summary-1, summary-2, summary-3 . . . ) generated by the multiple summary generation subsystem 110 are then provided to a summary selection subsystem 116 for evaluation. The summary selection subsystem 116 evaluates the multiple summaries using multiple different selection techniques to select the best summary from the multiple generated summaries. For instance, as depicted in FIG. 1, in certain embodiments, the summary selection subsystem 116 may be configured to use a technique 1 summary selection subsystem 118 that uses a first selection technique to select one summary from multiple summaries generated for the content to be summarized. In alternate embodiments, the summary selection subsystem 116 may be configured to use a technique 2 summary selection subsystem 120 that uses a second selection technique to select one summary from multiple summaries generated for the content to be summarized, where the second selection technique is different from the first selection technique. While the embodiment depicted in FIG. 1 illustrates a first and a second selection technique, in alternate embodiments, various other selection techniques may be used by the summary selection subsystem to select a summary. Additional details of the processing performed by the summary selection subsystem to select a summary are described below.

In certain implementations, a user of the system 102 may provide an input indicating the type of summary selection technique 122 to be used by the summary selection subsystem 116 for selecting a summary from multiple summaries. In other approaches, the summary selection subsystem 116 may itself implement logic to select a default summary selection technique to be used to select a summary from multiple summaries. In certain other approaches, the system 102 may apply more than one technique (e.g., the first selection technique and the second selection technique) to the multiple summaries. The system then can identify the “best” summary to be selected using the different techniques.

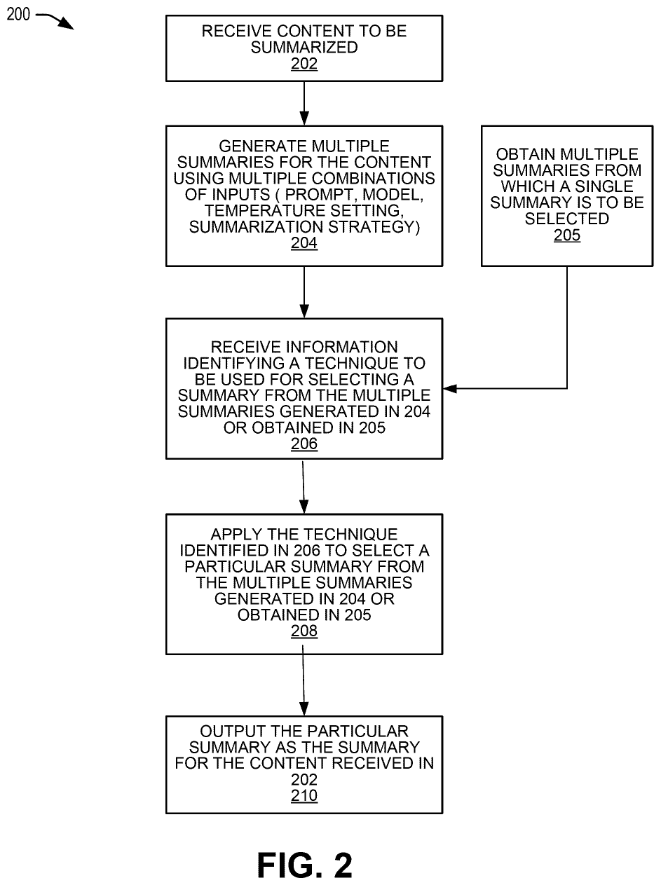

The results of the processing performed by the summary selection subsystem 102 are then communicated back to the requesting user. These results may include a selected summary 124 for the content to be summarized. In certain examples, the results transmitted to the user may additionally include the multiple summaries generated by the subsystem 110 for the content to be summarized. For instance, if the content to be summarized 104 represents a hospital note for a patient as described above, the results generated by the system may include multiple discharge summaries and the selected discharge summary. Details related to the processing performed by the various systems and subsystems in FIG. 1 for generating multiple summaries and then selecting a summary are described below with respect to the flowcharts depicted in FIGS. 2-11 and their accompanying description.

FIG. 2 depicts a simplified flowchart 200 depicting the processing performed by the system 102 shown in FIG. 1, according to certain embodiments. The processing depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 2 may be performed by the multiple summary generation subsystem 110 and the summary selection subsystem 116 described in FIG. 1.

At block 202, the multiple summary generation subsystem 110 receives content (e.g., 104) to be summarized. As previously described, the subsystem 110 may be configured to summarize various types of content such as news articles, research papers, hospital notes, technical documents, and so on. The content to be summarized may include charts, graphs, images and so on.

At block 204, the multiple summary generation subsystem generates multiple summaries for the content using multiple combinations of input parameters. The input parameters may include, but are not limited to, the configuration (type) of the model 108 to be used to create the summaries, the prompts 114 provided to the model, the summarization strategy 106 (e.g., chain of thought prompting technique, a multi-hop question answer evaluation) used by the model to create the summaries, the temperature setting 109 used by the model to control the randomness of the created summaries, and so on. The prompt is a specific input (initial step) provided to the system that requests the system to perform a specific task (e.g., to generate multiple summaries). For instance, in the context of a medical summary domain, a prompt may represent an input such as “Summarize the following note: \n{hospital_notes}.” In a certain implementation, the prompt may be automatically generated by a prompt generator 112 (shown in FIG. 1) and provided to the multiple summary generation subsystem for analysis. In other implementations, the prompt can be manually provided by a user of the system 102. The temperature setting is used to determine how likely the model is to come up with different options for the next word during generation of a summary. A higher temperature setting increases the randomness of the summaries so that the generated summaries are more likely to be different from each other. In a specific implementation, a temperature setting of 0.2 may be used. In other implementations, other values of temperature settings may be used.

In certain examples, at block 205, instead of generating the multiple summaries, the system 102 can alternatively, obtain the multiple summaries for analysis from an external source (e.g., a cloud service or a third party system). The multiple summaries can then be provided to the summary selection subsystem for evaluation.

At block 206, the summary selection subsystem 116 receives information identifying a particular technique to be used for selecting a summary from the multiple summaries generated in 204. The summary selection system 116 may utilize various approaches for selecting a particular summary. As previously described, the summary selection subsystem 116 may be configured to use a technique 1 summary selection subsystem 118 that uses a first selection technique to select one summary from multiple summaries generated for the content to be summarized. In alternate embodiments, the summary selection subsystem 116 may be configured to use a technique 2 summary selection subsystem 120 that uses a second selection technique to select one summary from multiple summaries generated for the content to be summarized, where the second selection technique is different from the first selection technique. Additional details of the different selection techniques used by the summary selection subsystem are described in detail below.

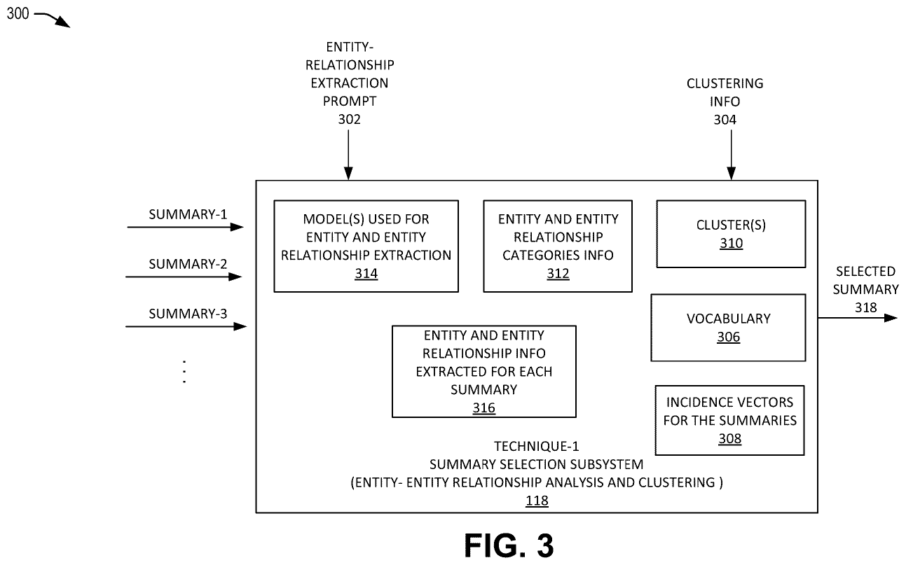

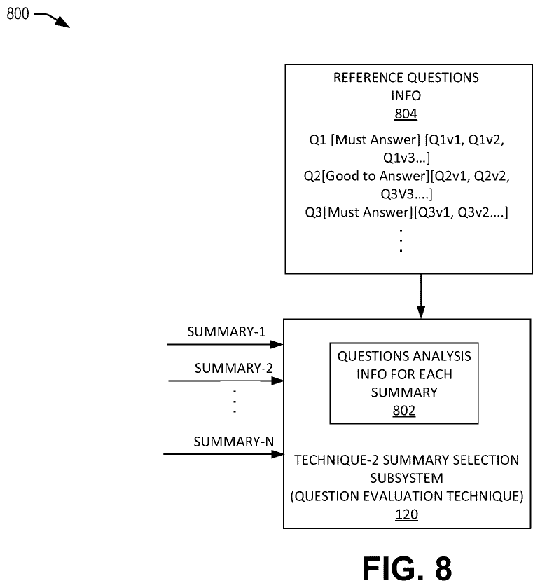

At block 208, the summary selection subsystem applies the technique identified in 206 to select a particular summary from the multiple summaries generated in 204 or obtained in 205. FIG. 3-FIG. 7 describe details of the processing performed by the summary selection subsystem to select a particular summary from among multiple generated summaries using a first selection technique. FIG. 8-FIG. 11 describe details of the processing performed by the summary selection subsystem to select a particular summary from among multiple generated summaries using a second selection technique.

At block 210, the summary selection subsystem outputs the particular summary as the summary 124 for the content received in 202. In certain examples, the output may be transmitted to a user of the system 102 where the output is displayed to the user via the user's device.

FIG. 3 is a simplified block diagram of the information blocks and functionality provided by the technique-1 summary selection subsystem 118 shown in FIG. 1 for selecting a summary from among multiple generated summaries, according to certain embodiments. In certain implementations, the technique-1 summary selection subsystem 118 uses a first selection technique that is based on entity-entity relationship analysis and clustering to select a summary from among multiple summaries generated for content to be summarized. In a first stage of processing, the subsystem 110 extracts relevant information (key elements) from the content to be summarized by identifying a set of entities and a set of entity relationships from the content to be summarized. The entities and entity relationships are identified based on the type of content to be summarized and the domain associated with the content. For instance, in the context of a medical domain, the type of content to be summarized may represent a hospital note. The entities identified for a hospital note may include, for instance, the patient's name, the patient's age, the patient's gender, the doctor, the medication prescribed and so on. The entity relationships identified for the hospital note identify an association between one or more entities identified in the hospital note. As an example, if the entities identified from a hospital note are “Dr. Smith” and “Acetaminophen”, an entity relationship identifies an association between the entities, such as “Dr. Smith->prescribed->Acetaminophen.”

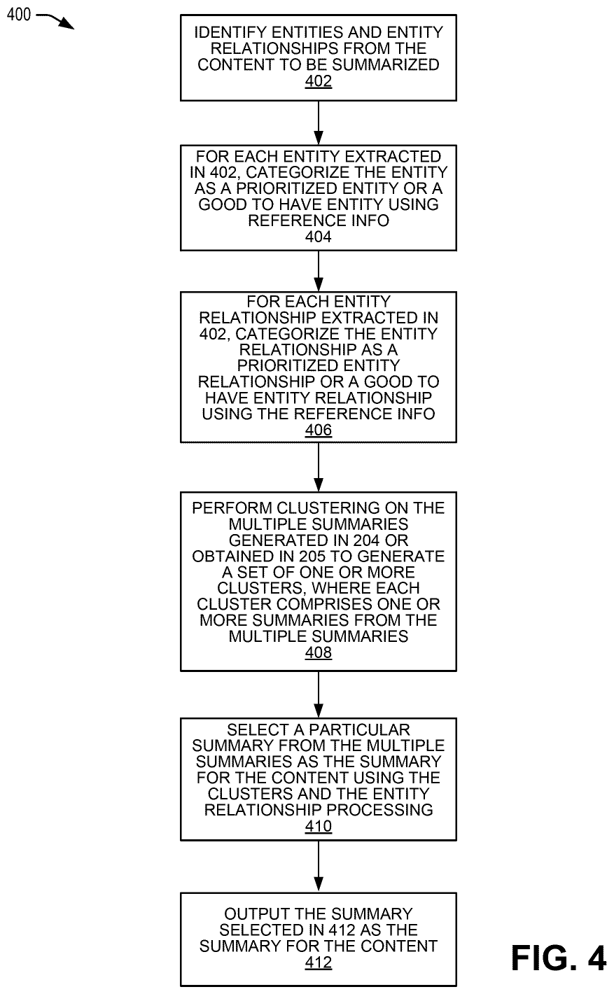

In certain examples, the entities and the entity relationships for the content to be summarized are identified by the subsystem 118 using a model 314 (e.g., an LLM) and an entity-relationship extraction prompt 302. The entity relationship extraction prompt 302 represents a small number of examples (e.g., 1-5) that are used by the LLM to identify entities and entity relationships from the content to be summarized. The identified entities and entity relationships are then categorized using entity and entity relationship categories information 312. Additional details of the categorization of entities and entity relationships is described in detail in FIG. 4 below. In alternate implementations, the subsystem 118 may utilize other types of models to extract relevant information such as entities and relationships from the content to be summarized. For instance, in one example, the subsystem 118 may use a large multimodal model (e.g., GPT-4) to identify entities and entity relationships from the content to be summarized, without specific training examples. In other examples, the subsystem 118 may use a pre-trained model (e.g., a BERT model) that uses named-entity recognition and entity linking for extracting entities and entity relationships from the content to be summarized.

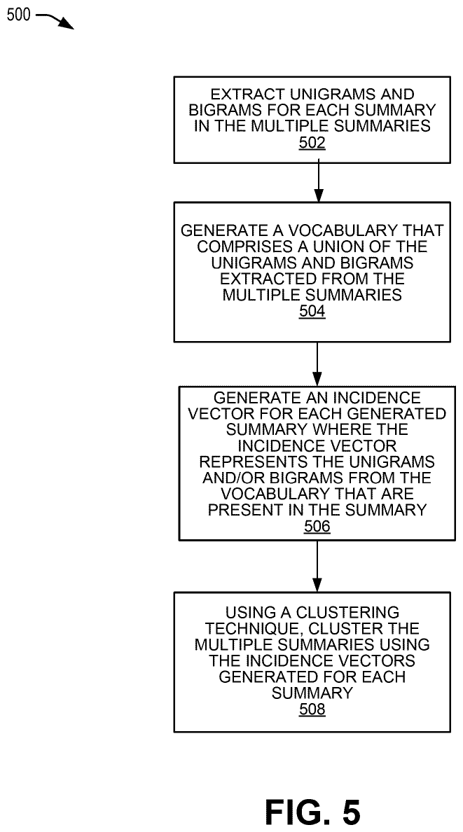

After identifying entities and entity relationships from the content to be summarized as described above, the subsystem 118 generates one or more clusters of summaries 310. The clusters 310 are generated using clustering information 304 that identifies a type of clustering technique used by the subsystem 118 to generate the clusters. As part of cluster generation, the subsystem 118 creates a vocabulary 306 and incidence vectors 308 for each summary. Additional details of the processing performed by the subsystem 118 to create a vocabulary and incidence vectors are described in FIG. 5. The subsystem 118 then selects a cluster of summaries for further analysis using the incidence vectors and entity and entity relationship information extracted for each summary 310. The subsystem 118 analyzes the summaries within a selected cluster to identify a particular summary that is deemed to be the “best” among the multiple generated summaries for the content to be summarized. Details of processing performed by the subsystem 118 to select a particular summary from multiple summaries using entity-entity relationship analysis and clustering is described in detail in FIGS. 4-7.

FIG. 4 is a simplified flowchart 400 depicting the processing performed by the subsystem 118 for selecting a particular summary for the content to be summarized using entity-entity relationship analysis and clustering, according to certain embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 4 may be performed by the technique-1 summary selection subsystem 118 described in FIG. 1.

In the embodiment depicted in FIG. 4, processing may be initiated at block 402 when the subsystem 118 identifies (extracts) a set of entities and a set of entity relationships from the content to be summarized. In a certain implementation, the set of entities and the set of entity relationships are identified from the content to be summarized using a few-shot prompting technique. The few-shot prompting technique refers to a technique in which a model (e.g., an LLM) is provided with a prompt (which may represent small number of examples (e.g., 1-5)) that illustrates a task to be performed by the model. The model uses the prompt to infer the underlying patterns or rules necessary to perform a new task. The type of prompt provided to the LLM may be specific to the type of content being summarized by the LLM. For instance, if the content to be summarized represents a hospital note, the type of prompt provided to the LLM may be an entity-relationship extraction prompt used to identify entities and relationships from the content to be summarized. An example of an entity-relationship prompt provided to the LLM is shown in Example-1 and Example-2 below:

Example 1: ‘Dr. Smith prescribed 5 mg of Acetaminophen to the patient.’
Entities: Dr. Smith (Doctor), Acetaminophen (Medication), 5 mg (Dosage), patient (Patient)
Entity Relationships: Dr. Smith->prescribed->Acetaminophen, Acetaminophen->dosage->5 mg, Dr. Smith->prescribed to->patient.

Example 2: ‘The patient, a 45-year-old male, shows symptoms of mild depression.’
Entities: patient (Patient), 45-year-old (Age), male (Gender), mild depression (Symptom)
Entity Relationships: patient->shows->symptoms, symptoms-> of->mild depression

Example 1 and Example 2 represent a set of examples that are provided as an entity-relationship prompt to the LLM for analysis. Each example (Example 1, Example 2) is composed of an input sentence, a set of entities identified from the input sentence and a set of entity relationships identified from the input sentence. For instance, in Example 1, the input sentence is ‘Dr. Smith prescribed 5 mg of Acetaminophen to the patient.’ The set of entities identified from the input sentence are “Dr. Smith,” “Acetaminophen,” “5 mg,” and “patient.” The set of entity relationships identified from the input sentence are “Dr. Smith->prescribed->Acetaminophen,” “Acetaminophen->dosage->5 mg” and “Dr. Smith->prescribed to->patient.” Similarly, in Example 2, the input sentence is ‘The patient, a 45-year-old male, shows symptoms of mild depression.’ The set of entities identified from the input sentence are “patient”, “45-year-old”, “male”, and “mild depression.” The set of entity relationships identified from the input sentence are “patient->shows->symptoms”, and “symptoms-> of->mild depression.”

In certain examples, each entity identified in an input sentence of an entity-relationship prompt is associated with an entity category. For instance, in Example 1, the entity “Dr. Smith,” is associated with an entity category “Doctor,” the entity “Acetaminophen,” is associated with an entity category “Medication,” the entity “5 mg,” is associated with an entity category “Dosage,” and the entity “patient” is associated with an entity category “Patient.” Similarly, in Example 2 shown above, the identified entities and corresponding entity categories are “patient (Patient),” “45-year-old (Age),” “male (Gender),” and “mild depression (Symptom).”

Using the entity relationship extraction prompt (i.e., example 1 and example 2) described above and the LLM 314, the subsystem 118 then identifies a set of entities and a set of entity relationships from content to be summarized. For instance, an example of content to be summarized is shown below:
Content to be summarized: ‘Pt is a 70 year old Hispanic female with diabetes . . . ’

The LLM uses the entity-relationship prompt (i.e., example 1 and example 2) described above to extract a set of entities and a set of entity relationships from the content to be summarized as shown below:
Entities: 70 (age), Hispanic (ethnicity), female (gender), and diabetes (medical condition).
Entity Relationships: Pt->shows->diabetes

As may be observed, the entities that are identified from the content to be summarized by the LLM are “70,” “Hispanic,” “female,” and “diabetes.” The entity categories corresponding to the identified entities are “age,” “ethnicity,” “gender,” and “medical condition.” The identified entity relationships are “Pt->shows->diabetes.”

At block 404, for each entity extracted from the content to be summarized, the subsystem categorizes the entity as a prioritized entity (i.e., a must-have entity) or a good-to-have entity using reference information. In a certain implementation, the reference information is stored as part of the entity and entity relationship categories information 312 in the subsystem 118. As part of the processing performed in block 404, the subsystem 118 first determines the entity category identified for the entity in the content to be summarized. The subsystem 118 then uses the reference information to determine if the entity category is a prioritized entity category or a good-to-have entity category. The subsystem 118 then categorizes each entity extracted from the content to be summarized as a prioritized entity or a good-to-have entity where a prioritized entity corresponds to one or more prioritized entity categories stored as part of the reference information. Similarly, the good-to-have entities correspond to one or more good-to-have entity categories stored as part of the reference information. As described herein, a prioritized entity is defined as an entity that is deemed to be an essential part of a good summary. A good-to-have entity is defined as an entity that is deemed to be a desirable or an optional part of a good summary. As described herein, a good summary is one that properly and accurately represents the content being summarized.

As a result of the processing performed in block 404, the subsystem 118 identifies a set of prioritized entities and a set of good-to-have entities present in the content to be summarized. For instance, using the example of the content to be summarized: ‘Pt is a 70 year old Hispanic female with diabetes . . . ’ shown above, the identified entities are (“70,” “Hispanic,” “female,” and “diabetes”) and the entity categories corresponding to the entities are (“age,” “ethnicity,” “gender,” and “medical condition”) respectively. Using the reference information, the subsystem 118 determines if the entity category is a prioritized entity category or a good-to-have entity category. The subsystem 118 then categorizes each entity extracted from the content to be summarized as a prioritized entity or a good-to-have entity based on the entity categories stored as part of the reference information. For instance, in one implementation, the entity categories, “age,” “gender,” may be categorized by the subsystem 118 as prioritized entity categories while the entity categories “ethnicity,” and “medical condition,” may be categorized as good-to-have entity categories. The subsystem identifies a set of prioritized entities present in the content to be summarized based on the prioritized entity categories identified in the reference information. The system also identifies a set of good-to-have entities present in the content to be summarized based on the good-to-have entity categories identified in the reference information. For instance, the entities “70,” and “diabetes” may be identified as prioritized entities while the entities “Hispanic,” and “Female,” may be identified as good-to-have entities. In certain examples, the prioritized entity categories and the good-to-have entity categories described above may be defined by a subject matter expert and stored as part of reference information by the subsystem 118.

Examples of prioritized entity categories and good-to-have entity categories that are stored as part of reference information for a medical domain is shown in table-1 below:

TABLE-1

| Prioritized Entity Category | Good-to-have Entity Category |
|---|---|
| Date of Admission | Ethnicity |
| Date of Discharge | Medical Condition |
| Reason for Admission | Length of Stay |
| Personal Demographics | Diet |
| Age | Physical Exam on admission |
| Gender | Daily Progress Note Summary |

Table-1 shown above is merely an example and not intended to unduly limit the scope of claimed embodiments. One of ordinary skill in the art would recognize many possible variations, alternatives, and modifications. For example, in some implementations, the table may be implemented using more or fewer columns than those shown in FIG. 3, may combine two or more columns of information, or may have different columns than shown in the illustration. Additionally, while the implementation shown in Table-1 depicts certain examples of prioritized entity categories and good-to-have entity categories, in other implementations, Table-1 may include more or fewer or different examples of prioritized entity categories and good-to-have entity categories.

After categorizing each entity extracted from the content to be summarized as described above as a prioritized entity or a good-to-have entity, the subsystem performs similar processing to identity a set of prioritized entity relationships and a set of good-to-have entity relationships present in the content to be summarized. At block 406, for each entity relationship extracted from the content to be summarized in 402, the subsystem 118 categorizes the entity relationship as a prioritized entity relationship or a good-to-have entity relationship using the reference information. The prioritized entity relationships correspond to one or more prioritized entity relationship categories stored as part of the reference information. Similarly, the good-to-have entity relationships correspond to one or more good-to-have entity relationship categories stored as part of the reference information. As described herein, a prioritized entity relationship is defined as an entity relationship that is deemed to be an essential part of a good summary. A good-to-have entity relationship is defined as an entity relationship that is deemed to be a desirable or an optional part of a good summary. In certain examples, the entity relationship categories described above may be defined by a subject matter expert and stored as part of reference information by the subsystem 118. For instance, the entity relationship, Pt->shows->diabetes extracted from the content to be summarized may be categorized as a prioritized entity relationship, in one implementation.

At block 408, the subsystem 118 performs clustering on the multiple summaries generated in 204 to generate a set of one or more clusters. Each cluster comprises one or more summaries from the multiple summaries. Additional details of the processing performed by the subsystem 118 to generate clusters of summaries is described in detail in FIG. 5.

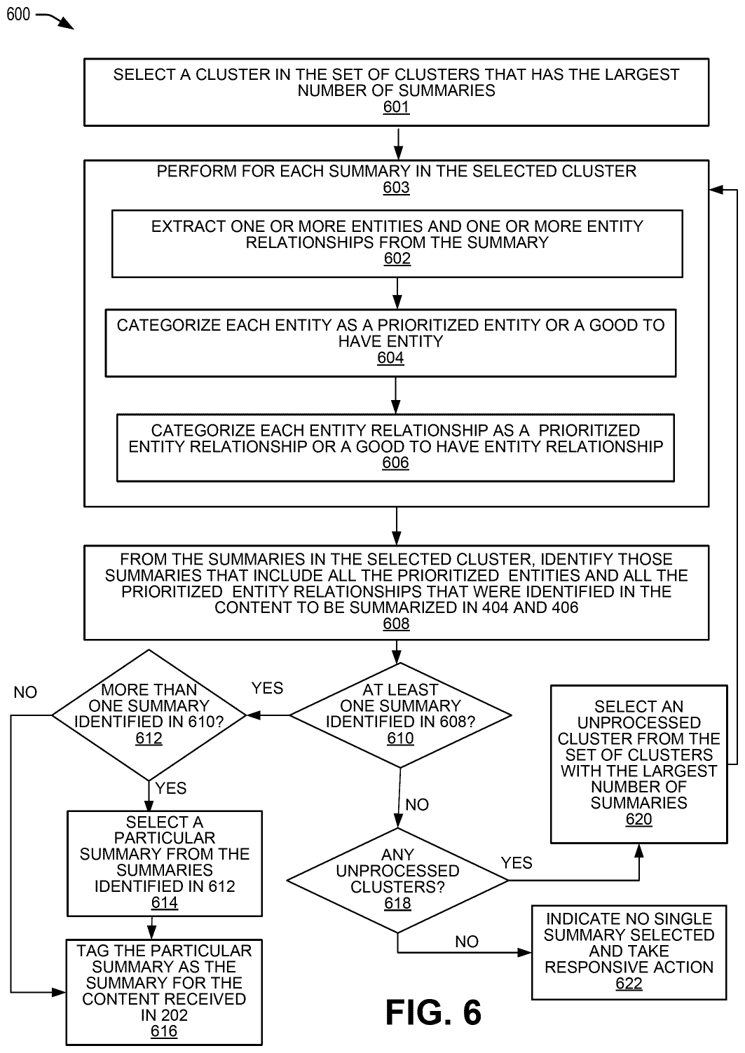

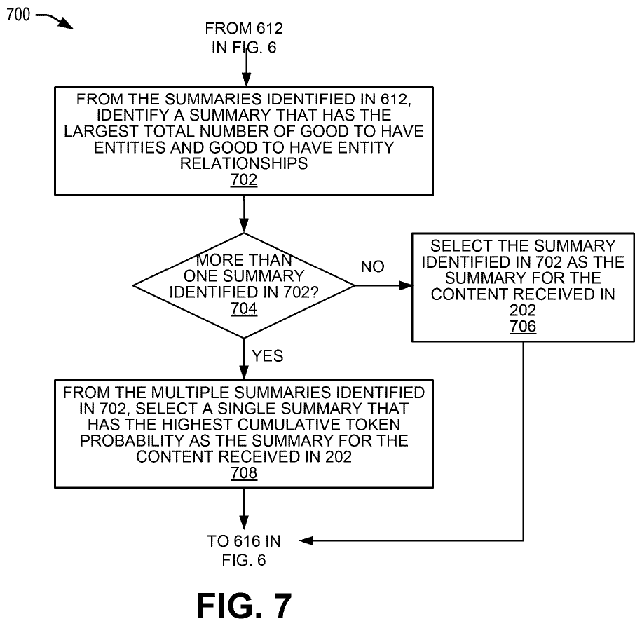

At block 410, the subsystem selects a particular summary from the multiple summaries as the summary for the content using the clusters and the entity relationship processing. In certain examples, the selected summary includes all the prioritized entities and all the prioritized entity relationships that were identified in the content to be summarized. Additional details of the processing performed by the subsystem 118 to select a particular summary from the multiple summaries is described in detail in FIG. 6 and FIG. 7.

At block 412, the subsystem outputs the summary selected in 412 as the summary for the content.

An example of a hospital discharge summary that is generated and output by the system as a selected hospital discharge summary for a hospital note is shown below:

John Doe, a 22-year-old male with a past medical history of Type 1 diabetes, was admitted to
the medical ICU on 1 Jul. 2023 with a 2-day history of severe polyuria, polydipsia, and
general malaise. He has also been vomiting since this morning. The patient has had difficulty
managing his glucose levels in the past due to inconsistent use of insulin. He usually
administers insulin glargine 20 units daily and uses insulin lispro for meals. However, he has
run out of his insulin supplies for the past three days. Mr. Doe is also suffering from a cold
over the past week and has been taking over-the-counter cold medications.
On admission, the patient's vital signs were BP 110/70, P-115, R-26, T-37.5° C. The physical
exam showed tachypnea and a dry mucous membrane. The labs revealed a WBC 10,000/uL,
Hgb 14 g/dL, Hct 42%, Plt 200,000/uL. The CMP showed Na 134 mEq/L, K 4.7 mEq/L, Cl
102 mEq/L, CO2 18 mEq/L, BUN 25 mg/dL, Creatinine 1.0 mg/dL, Glucose 480 mg/dL. The
arterial blood gas (ABG) revealed a pH 7.25, pCO2 28 mmHg, HCO3— 12 mEq/L, PaO2 98
mmHg on room air. The urinalysis was positive for glucose and ketones

### Example of a Hospital Discharge Summary

The hospital discharge summary illustrated above is merely an example of a summary generated by the system for a hospital note and is not intended to unduly limit the scope of claimed embodiments. One of ordinary skill in the art would recognize many possible variations, alternatives, and modifications. For example, in some implementations, the system may generate other different summaries for the same content based upon changes to the configuration of the LLM, the types of prompts provided to the LLM, the summarization strategy used (e.g., chain of thought prompting technique, a multi-hop question answer evaluation) by the LLM, the input parameters (setup) for the model, the temperature setting used for the model to control the randomness, and the like. As a result, for the same content to be summarized, the system may create multiple summaries that are different in terms of content and accuracy. In addition, while the example illustrated above is an example of a hospital discharge summary that is generated by the system, in alternate embodiments, the system may include capabilities to generate summaries for various other types of content such as such as documents, webpages, news articles, research papers and so on.

FIG. 5 depicts a simplified flowchart 500 depicting the processing performed by subsystem 118 for generating clusters of summaries, according to certain embodiments. The processing depicted in FIG. 5 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 5 describes additional details of the processing performed in block 408 of FIG. 4.

At block 502, the subsystem 118 receives the multiple summaries and extracts unigrams and bigrams for each summary in the multiple summaries. The multiple summaries may be generated as part of the processing performed in 204 or the multiple summaries may be obtained as part of the processing performed in 205. In certain implementations, a summary may be represented as a bag-of-words comprising single words (unigrams) and a sequence of two words (bigrams). For instance, unigrams extracted from a hospital discharge summary may include single words such as “Joan,” “is,” “a,” “female,” and the bi-grams extracted from the hospital discharge summary may include two-word sequences such as “Joan is”, “a female”, and so on.

At block 504, the subsystem generates a vocabulary that comprises a union of all the unigrams and bigrams extracted from each summary in the multiple summaries.

At block 506, the subsystem generates an incidence vector for each generated summary, where the incidence vector represents the unigrams and bigrams from the vocabulary that are present in the summary. In a certain implementation, the incidence vector is represented as a binary vector, where a value of 1 in the binary vector for a summary indicates that a particular unigram or bigram from the vocabulary is present in the summary and a value of 0 in the binary vector for the summary indicates that a particular unigram or bigram from the vocabulary is not present in the summary.

At block 508, the subsystem uses a clustering technique to cluster the multiple summaries based on the incidence vectors generated for each summary. In a certain implementation, the subsystem uses a K-means clustering technique to generate one or more clusters of summaries where each cluster comprises one or more incidence vectors that represent one or more summaries from the multiple summaries. The K-means clustering technique is a commonly used clustering technique that is used to cluster data points into distinct groups (i.e., into a predefined number of k-clusters). Using K-means clustering, the data points (i.e., incidence vectors, in this case) that are similar to one another are added to the same cluster. In certain examples, the similar incidence vectors are identified by measuring the distance between each of the incidence vectors generated for each of the summaries. The k-means algorithm uses an iterative approach to find the optimal cluster assignments by minimizing the sum of squared distances between the data points (i.e., incidence vectors) and their assigned cluster centroid. Upon creating one or more clusters of summaries as described above, the subsystem 118 then selects a particular cluster of summaries for further analysis. Details of the processing performed by the subsystem 118 for a selected cluster of summaries is described in FIG. 6 and FIG. 7 below.

FIG. 6 depicts a simplified flowchart 600 depicting the processing performed by subsystem 118 for selecting a summary from one or more summaries that are part of a selected cluster of summaries, according to certain embodiments. The processing depicted in FIG. 6 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 6 describes additional details of the processing performed in block 410 and describes the processing performed by the technique-1 summary selection subsystem 118 described in FIG. 1.

At block 601 the subsystem 118 selects a cluster in the set of clusters (generated in block 408) that has the largest number of summaries.

At block 603, the subsystem 118 performs the processing described in blocks 602-606 for each summary in the selected cluster. At block 602, the subsystem extracts one or more entities and one or more entity relationships from the summary. In one implementation, the subsystem 118 may utilize the few shot prompting technique and the prompt (example 1 and example 2) described above to extract entities and entity relationships from the summary. At block 604, the subsystem categorizes each entity as a prioritized entity or a good-to-have entity using the reference information described in FIG. 4. At block 606, the subsystem categorizes each entity relationship as a prioritized entity relationship or a good-to-have entity relationship using the reference information.

At block 608, the subsystem 118 identifies those summaries in the selected cluster that include all the prioritized entities and all the prioritized relationships that were identified in the content to be summarized in 404 and 406.

At block 610, the subsystem 118 determines if there is at least one summary identified in 608. If the subsystem determines that there is only one identified summary and the identified summary in the selected cluster includes all the prioritized entities and all the prioritized entity relationships that were identified in the content to be summarized, then the processing proceeds to block 616, where the subsystem 118 tags the particular summary as the summary for the content received in 202.

If the subsystem determines that there is more than one identified summary in 612, the processing proceeds to block 614, where the subsystem applies a selection technique to select a particular summary from the summaries identified in 612. Additional details related to the type of selection technique used and the processing performed by the subsystem to select a particular summary using the selection technique is described in FIG. 7. Upon selecting a particular summary using the selection technique, the processing then proceeds to block 616 where the subsystem 118 tags the particular summary as the summary for the content received in 202.

If at block 610, the subsystem determines that no summary was identified as a result of the processing performed in block 608, then at block 618, the subsystem determines if there are any unprocessed clusters. If there are any clusters that are still to be processed, at block 620, the subsystem selects an unprocessed (i.e., new) cluster from the set of clusters with the largest number of summaries and then proceeds to block 603 to perform the processing described in 602-606 for each summary in the selected cluster. If there are no more clusters to be processed and the subsystem has not identified/selected any summary from the multiple summaries as a summary for the content, then in block 622, the subsystem indicates that no single summary has been selected and takes responsive action. For example, the responsive action taken by the subsystem can be to generate a new set of summaries for the content to be summarized and repeat the processing on the new set of summaries.

FIG. 7 depicts a simplified flowchart 700 depicting the processing performed by the subsystem 118 for selecting a summary from the multiple summaries, according to certain embodiments. The processing depicted in FIG. 7 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 7 and described below is intended to be illustrative and non-limiting. Although FIG. 7 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 7 may be performed by the technique-1 summary selection subsystem 118 described in FIG. 1 and describes additional details of the processing performed in block 612 in FIG. 6.

At block 702, from the summaries identified in 612, the subsystem identifies a summary that has the largest total number of prioritized entities and good-to-have entity relationships. At block 704, the subsystem determines if there is more than one summary identified in 704. If there is only one summary identified in 704, then at block 706, the subsystem selects the summary identified in 702 as the summary for the content received in 202. If there is more than one summary identified in 704, then the subsystem applies a selection technique to select a single summary from the multiple summaries identified in 702. In one implementation, the selection technique uses a token selection strategy to select the single summary. The token selection strategy refers to a selection technique in which the LLM takes an input sequence of tokens (which can comprise, words, letters or word units) identified in a summary to predict the next token. The LLM assigns probabilities to all possible tokens based on its understanding of the summary content and selects the next token based on these probabilities. The LLM then selects the summary that has the highest cumulative token probability as the summary for the content received in 202. In certain examples, the cumulative token probability is calculated by summing the log probabilities of each token in a sequence. To select a summary based on token probabilities, in certain examples, the LLM uses the average log probability (by summing the log probabilities and dividing by the number of tokens in the summary) to avoid length bias. This normalized score enables fair comparison across summaries of varying lengths. The summary with the highest average log probability, indicative of the most probable sequence of tokens, is chosen. The processing then selects the summary with the highest average log probability as the summary for the content received in 202.

As previously described, in certain instances, the summary generation and summary selection system may be configured to use a second selection technique that uses second criteria to select a summary from multiple summaries generated for content to be summarized, where the second technique is different from the first technique described in FIGS. 3-7 above. In certain embodiments, the second summary selection technique uses a questions-based analysis approach to select a summary from multiple summaries generated for content to be summarized. Additional details of the processing performed by the second summary selection technique to select a summary is described in detail in FIGS. 8-10 below.

FIG. 8 is a simplified block diagram of the information used and the functionality provided by the technique-2 summary selection subsystem 120 shown in FIG. 1 for selecting a summary from among multiple generated summaries, according to certain embodiments. In certain implementations, the technique-2 summary selection subsystem 120 uses a questions-based analysis approach to select a summary from among multiple summaries generated for content to be summarized. In this approach, the subsystem 120 first obtains a reference set of questions that an effective summary should answer. The reference set of questions may be created by a subject matter expert based on the domain of the content for which summarization is being performed. The subsystem 120 obtains a set of reference questions based on the domain of the content for which summarization is being performed and uses the set of reference questions to perform summary selection.

The reference set of questions shown in Table-2 below identify a set of questions that an effective hospital discharge summary should answer. In certain examples, each question in the reference set of questions (as shown in table-2) may have multiple variants or versions. In addition, each question in the reference set of questions may be categorized (e.g., by the subject matter expert) as a “prioritized” question (also referred to herein as a “must-answer” question) or a “good-to-answer” question. As described herein, a prioritized question is defined as an essential question that is to be answered by a summary. A good-to-answer question is defined as an optional question that is to be answered by a summary.” In certain examples, the categorization of the questions in the reference set of questions as prioritized questions or good-to-answer questions may be performed by the subject matter expert or by a user of the system. By way of example, in one implementation, for a reference set of questions that relate to a hospital discharge summary as shown in table-2 below, questions that relate to the admission date (e.g., Has the date of admission been specified), the discharge date (e.g., Has the date of discharge been mentioned?) and personal demographics (e.g., Is the name, age and gender of the patient provided) may be categorized as prioritized questions. Questions that relate to the clinical data and vitals of the patient and home medications may be categorized as good-to-answer questions.

TABLE-2

| Question | Variant-1 | Variant-2 |
|---|---|---|
| Has the date of admission | Is the admission | Is there a date he |
| been specified? | date given? | came into the |
| | | hospital? |
| Has the date of discharge | Is the discharge date | Is there a date he |
| been mentioned? | mentioned? | left? |
| Are the personal | Do we have the | Do we know his |
| demographics such as | patient's name, age, | name and age? |
| name, age and gender of | and gender? | |
| the patient provided? | | |
| What is the reason for the | Why was the patient | Why did he come |
| patient's admission? | admitted? | to the hospital? |
| Is there a summary of the | Do we have a | Why was he |
| admission criteria or | summary of why they | allowed in? |
| history? | were admitted? | |
| Was a physical exam | Was there a physical | Did a doctor |
| conducted upon admission? | exam when they came | check him when |
| If so, is it documented? | in? Is it written down? | he came? Is it |
| | | written down? |
| Are the clinical data and | Do we have their | Do we have his |
| vitals at the time of | health data and vital | health details |
| admission provided? | signs from when they | from when he |
| | arrived? | came? |
| Is there a summary of the | Do we have a | Do we know about |
| patient's medical and | summary of their past | his past health |
| surgical history? | medical and surgical | problems? |
| | details? | |
| Is there a summary of the | Do we have a list of | Do we know his |
| patient's home medications | their home | usual medicines? |
| and treatments? | medications and | |
| | treatments? | |
| Is the initial treatment plan | Do we have a | What did the |
| for the patient summarized? | summary of their first | doctors plan to do |
| | treatment plan? | for him? |
| Are any operations or | Do we have a | Do we know about |
| procedures the patient | summary of any | any surgeries or |
| underwent summarized? | surgeries or | treatments he had |
| | procedures they had? | here? |
| Is there a periodic summary | Do we have regular | Are there short |
| of events from the daily | summaries from daily | notes from each |
| notes? | notes? | day for him? |
| Are daily progress notes for | Are daily updates on | Are there daily |
| the patient summarized? | the patient | updates about him? |
| | summarized? | |
| Are relevant labs, imaging, | Are tests, pictures, | Did he have any |
| and treatments | and treatments written | tests or scans? Are |
| documented? | down? | they written down? |
| Are there notes on relevant | Are there notes on any | Did anything |
| physical findings during the | physical changes | change with his |
| hospital stay? | during their stay? | body during the |
| | | stay? |
| Were there any | Were there any expert | Did other experts |
| consultations? If so, are | opinions? Are they | see him? Is it |
| they summarized? | summarized? | written down? |
| Is there an assessment of | Do we know if the | Is he ready to |
| the patient's readiness | patient is ready to | leave? |
| for discharge? | leave? | |
| What are the discharge | What are the reasons | Why is he leaving? |
| diagnoses for the patient? | they're being | |
| | discharged? | |
| Is there a plan for the | What's the plan when | How will he be |
| patient's discharge? | the patient leaves? | cared for when |
| | | leaving? |
| What is the disposition | How is the patient | How is he feeling |
| upon discharge? | doing when they | when leaving? |
| | leave? | |
| Is there a follow-up plan | What's the plan after | What should he do |
| post-discharge? | they leave? | after leaving? |
| Are there any special | Are there any special | Should he do |
| activity instructions | things the patient | anything special |
| for the patient | should do after | after leaving? |
| post-discharge? | leaving? | |
| Are there specific dietary | Are there any food | What should he eat |
| recommendations for the | suggestions for the | when leaving? |
| patient upon discharge? | patient when they | |
| | leave? | |
| Are the medications to be | Is there a list of | What medicines |
| taken post-discharge listed? | medications for after | should he take |
| | they leave? | after leaving? |
| Is there a pain management | Do we have a plan for | How will his pain |
| plan for the patient post- | managing their pain | be managed after |
| discharge? | after they leave? | leaving? |
| What is the total length of | How long was the | How many days |
| the patient's stay in the | patient in the hospital? | was he in the |
| hospital? | | hospital? |

Table-2 shown above is merely an example and not intended to unduly limit the scope of claimed embodiments. One of ordinary skill in the art would recognize many possible variations, alternatives, and modifications. For example, in some implementations, the table may be implemented using more or fewer columns than those shown in FIG. 3, may combine two or more columns of information, or may have different columns than shown in the illustration. Additionally, while the implementation shown in Table-1 depicts certain examples of prioritized questions and good-to-answer questions, in other implementations, Table-2 may include more fewer, and different examples of prioritized questions and good-to-answer questions.

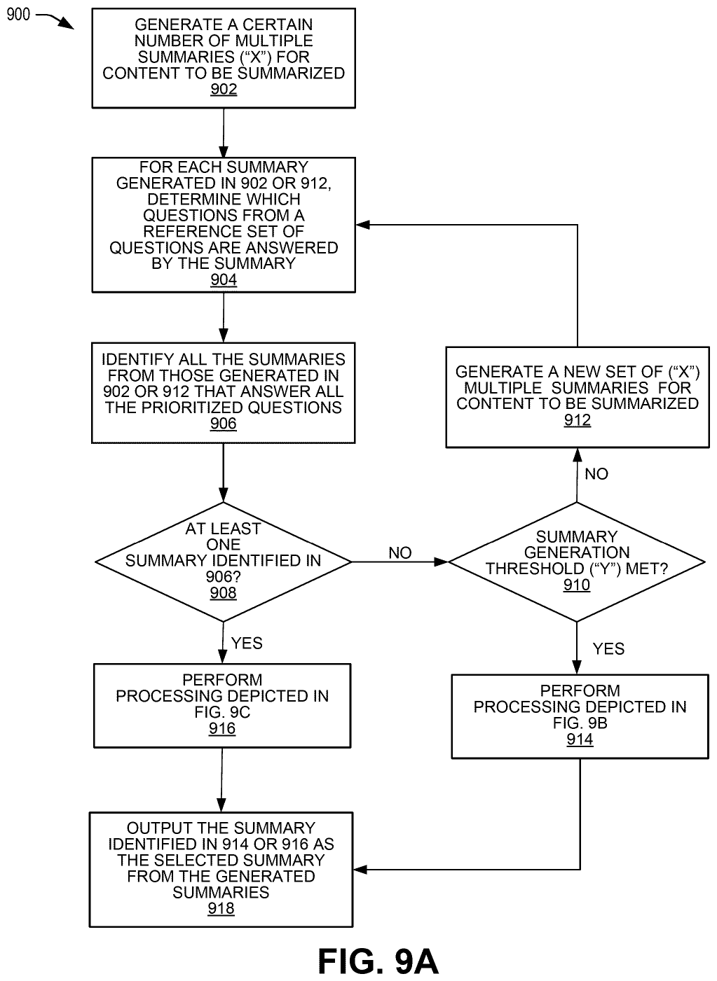

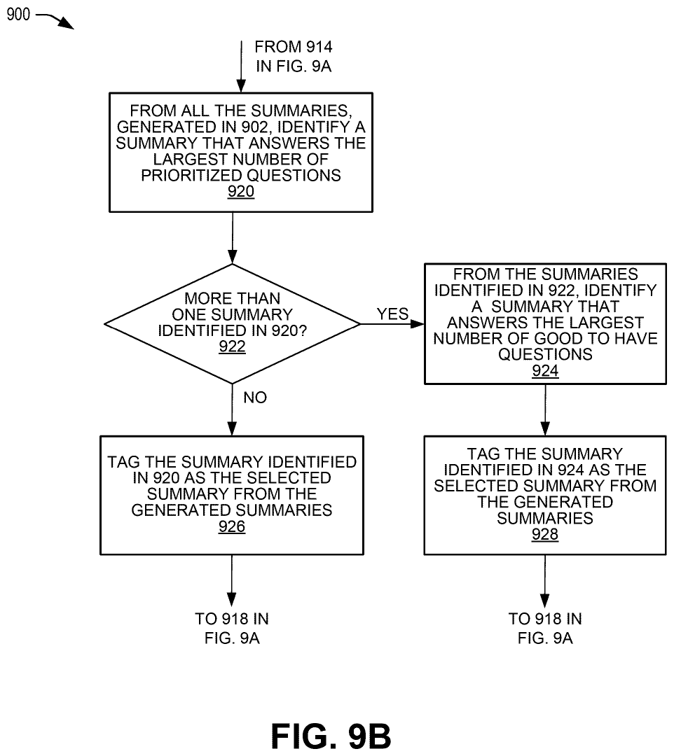

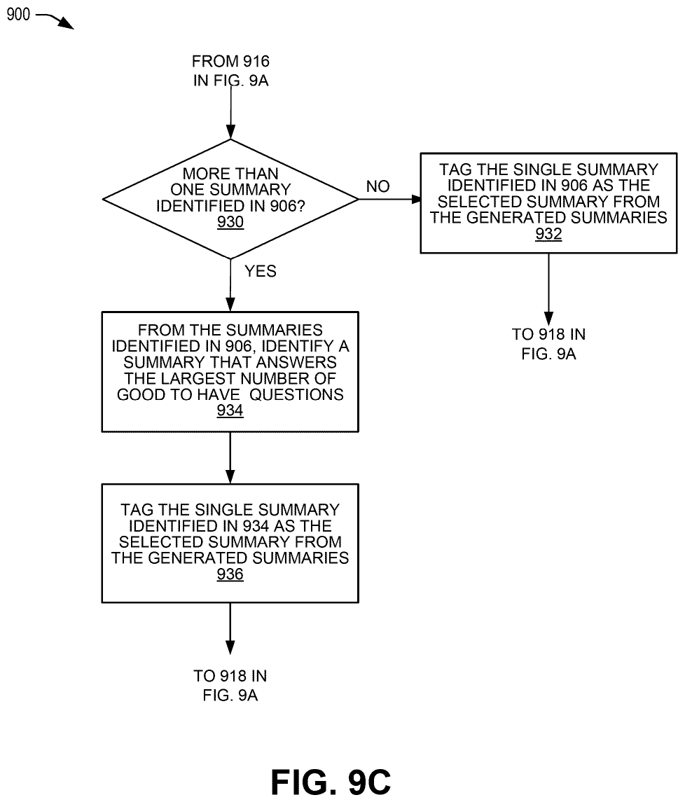

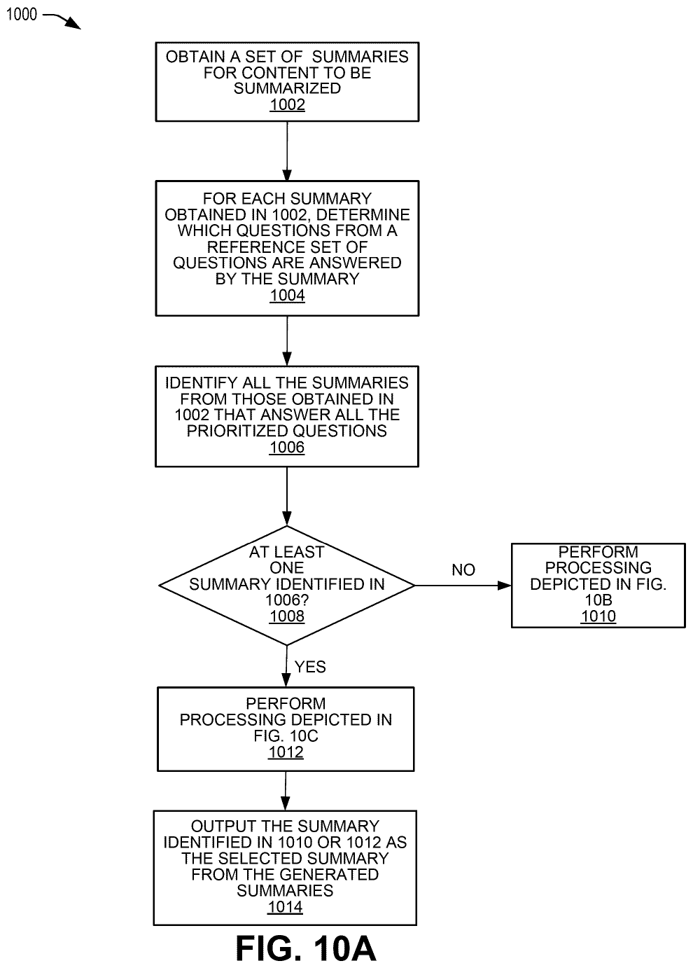

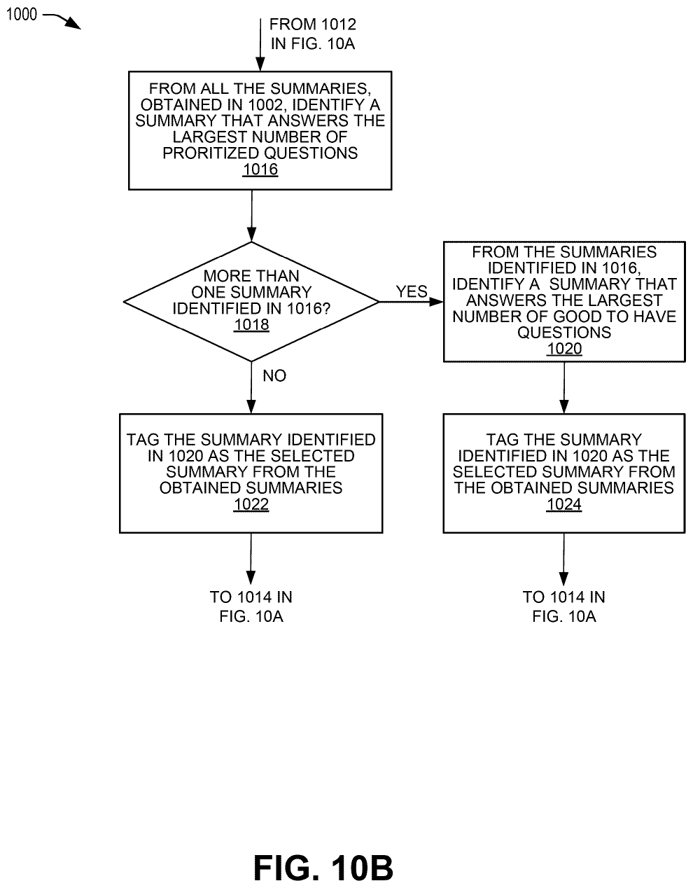

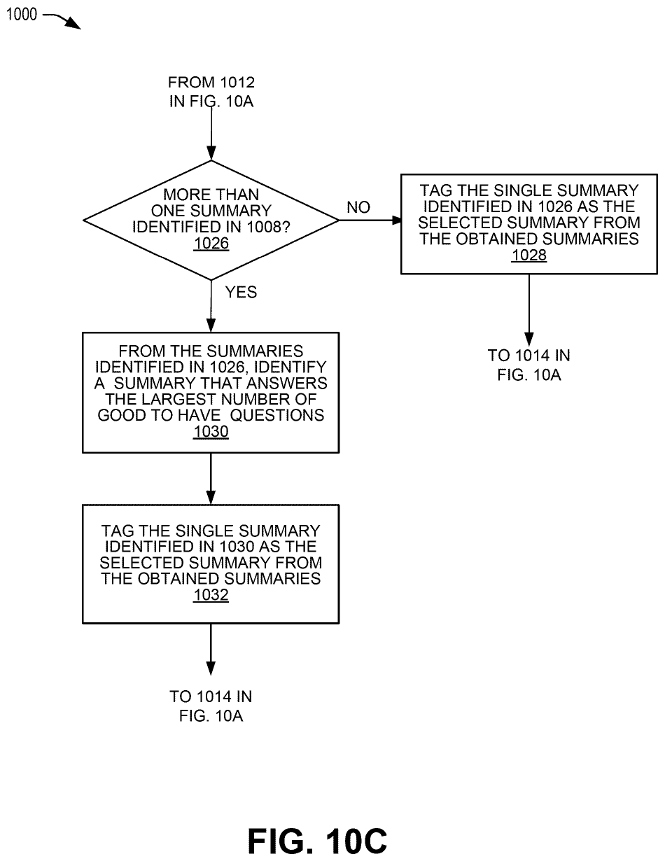

Upon obtaining a reference set of questions as described above, the subsystem 120 obtains multiple summaries to be evaluated and determines a set of prioritized questions identified in the reference set of questions that are answered by each summary. In a certain implementation, a question is considered answered if any of the question's variants are answered in the summary. The subsystem then selects a summary from the multiple summaries based upon the set of prioritized questions answered by each of the summaries in multiple summaries and provides the selected summary as a summary for the content to be summarized. Additional details of the processing performed by the subsystem to select a summary are discussed in detail in FIG. 9A, 9B and 9C. FIG. 10A, 10B and 10C describe an alternate embodiment implemented by the subsystem for selecting a summary.

FIG. 9A depicts a simplified flowchart 900 depicting the processing performed by the system 102 shown in FIG. 1 for selecting a summary from among multiple summaries, according to certain embodiments. The processing depicted in FIG. 9A may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 9A and described below is intended to be illustrative and non-limiting. Although FIG. 9A depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 9A may be performed by the technique-2 summary selection subsystem 120 in the summary selection subsystem 116 described in FIG. 1.

In certain examples, processing is initiated at block 902 by the multiple summary generation subsystem 110 by generating a certain number (e.g., X) of multiple summaries for content to be summarized. As previously described, various types of content may be summarized such as news articles, research papers, hospital notes, technical documents, and so on. The content to be summarized may include charts, graphs, images and so on. In a certain implementation, the content to be summarized may represent a hospital note as described above.

At block 904, for each summary generated at 902 (or alternatively generated at 912, described below), the subsystem 120 determines which questions from a reference set of questions (e.g., shown in table-2 above) are answered by the summary.

At block 906, the subsystem identifies all the summaries from those generated in 902 or 912 that answer all the prioritized questions identified in the reference set of questions.

At block 908, the subsystem 120 determines if at least one summary was identified in 906. If no summary was identified, then, at block 910, the subsystem 120 determines if a summary generation threshold (“y”) was met. The summary generation threshold represents a certain number (“y”) of iterations performed by the subsystem to generate a new set of summaries. If the summary generation threshold was met, the subsystem 120 performs the processing depicted in FIG. 9B. If the summary generation threshold was not met, then the processing proceeds to block 912, where the subsystem 120 generates a new set of (“x) multiple summaries for the content to be summarized and performs the processing described in blocks 904 and 906 for each summary generated in 912.

At block 908, if the subsystem determines that at least one summary was identified in 906, the subsystem performs the processing depicted in FIG. 9C. As a result of the processing performed in FIG. 9B or FIG. 9C, the subsystem outputs the summary identified in 914 or 916 as the selected summary from the generated summaries.

FIG. 9B depicts a simplified flowchart 900 depicting the processing performed by the technique-2 summary selection subsystem 120 shown in FIG. 1 to select a summary, according to certain embodiments. The processing depicted in FIG. 9B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 9B and described below is intended to be illustrative and non-limiting. Although FIG. 9B depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 9B describes additional details of the processing performed in block 914 in FIG. 9A.

At block 920, from all the summaries generated in 902, the subsystem identifies a summary that answers the largest number of prioritized questions. At block 920, the subsystem determines if there was more than one summary identified in 920. If there was more than one summary identified in 920, then at block 924, the subsystem 120 identifies a summary that answers the largest number of good-to-have questions. At block 926, the subsystem 120 tags the summary identified in 924 as the selected summary from the generated summaries and the processing proceeds to block 918 in FIG. 9A where the subsystem outputs the selected summary.

If only one summary was identified in 920, then at block 928, the subsystem 120 tags the identified summary as the selected summary from the generated summaries and the processing proceeds to block 918 in FIG. 9A where the subsystem outputs the selected summary.

FIG. 9C depicts a simplified flowchart 900 depicting the processing performed by the technique-2 summary selection subsystem 120 shown in FIG. 1 to select a summary, according to certain embodiments. The processing depicted in FIG. 9C may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 9C and described below is intended to be illustrative and non-limiting. Although FIG. 9C depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 9C describes additional details of the processing performed in block 916 in FIG. 9A.

At block 930, the subsystem 120 determines if more than one summary was identified as a result of the processing performed in 906. If only one summary was identified, then at 912 the subsystem 120 tags the single summary identified in 906 as the selected summary from the generated summaries and the processing proceeds to block 918 in FIG. 9A to output the selected summary. If more than one summary was identified in 906, then at 934, the subsystem 120 identifies a summary from the summaries that answers the largest number of good-to-have questions. At 936, the subsystem tags the single summary identified in 934 as the selected summary from the generated summaries and proceeds to perform the processing in block 918 in FIG. 9A to output the selected summary.

In certain implementations, and as described in FIG. 10A, FIG. 10B and FIG. 10 C below, the subsystem 120 may utilize an alternate approach to select a summary from among multiple summaries. In this approach, the subsystem does not generate a certain number of summaries for the content to be summarized but instead obtains a set of summaries for evaluation. The set of summaries may be obtained from a third party system or from a cloud service that utilizes the summary selection functionality provided by the subsystem 120. Upon obtaining a set of summaries for the content to be summarized, the subsystem 120 then selects a summary from the multiple summaries using the questions-based analysis technique described in FIG. 9A, 9B and 9C above.

FIG. 10A depicts a simplified flowchart 1000 depicting the processing performed by the system 102 shown in FIG. 1 for selecting a summary from among multiple summaries, according to certain embodiments. The processing depicted in FIG. 10A may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 10A and described below is intended to be illustrative and non-limiting. Although FIG. 10A depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 10A may be performed by the technique-2 summary selection subsystem 120 in the summary selection subsystem 116 described in FIG. 1.

In certain examples, processing is initiated at block 1002 when the subsystem 120 obtains a set of summaries for content to be summarized. As previously described, various types of content may be summarized such as news articles, research papers, hospital notes, technical documents, and so on. The content to be summarized may include charts, graphs, images and so on. In a certain implementation, the content to be summarized may represent a hospital note as described above.

At block 1004, for each summary obtained at 1002, the subsystem 120 determines which questions from a reference set of questions (e.g., shown in table-2 above) are answered by the summary.

At block 1006, the subsystem 120 identifies all the summaries from those generated in 1002 that answer all the prioritized questions identified in the reference set of questions.

At block 1008, the subsystem 120 determines if at least one summary was identified in 1006. If no summary was identified, then, at block 1010, the subsystem 120 performs the processing depicted in FIG. 10B. At block 1008, if the subsystem 120 determines that at least one summary was identified in 1006, the subsystem 120 performs the processing depicted in FIG. 10C. As a result of the processing performed in FIG. 10B or FIG. 10C, the subsystem 120 outputs the summary identified in 1010 or 1014 as the selected summary from the generated summaries.

FIG. 10B depicts a simplified flowchart 1000 depicting the processing performed by the technique-2 summary selection subsystem 120 shown in FIG. 1 to select a summary, according to certain embodiments. The processing depicted in FIG. 10B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 10B and described below is intended to be illustrative and non-limiting. Although FIG. 10B depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 10B describes additional details of the processing performed in block 1010 in FIG. 10A.

At block 1016, from all the summaries obtained in 1002, the subsystem 120 identifies a summary that answers the largest number of prioritized questions. At block 1018, the subsystem 120 determines if there was more than one summary identified in 1016. If there was more than one summary identified in 1016, then at block 1020, the subsystem 120 identifies a summary that answers the largest number of good-to-have questions. At block 1024, the subsystem 120 tags the summary identified in 1020 as the selected summary from the generated summaries and the processing proceeds to block 1014 in FIG. 10B where the subsystem outputs the selected summary.

If only one summary was identified in 1020, then at block 1022, the subsystem 120 tags the identified summary as the selected summary from the generated summaries and the processing proceeds to block 1014 in FIG. 10A where the subsystem outputs the selected summary.

FIG. 10C depicts a simplified flowchart 1000 depicting the processing performed by the technique-2 summary selection subsystem 120 shown in FIG. 1 to select a summary, according to certain embodiments. The processing depicted in FIG. 10C may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 10C and described below is intended to be illustrative and non-limiting. Although FIG. 10C depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 10C describes additional details of the processing performed in block 1012 in FIG. 10A.

At block 1026, the subsystem 120 determines if more than one summary was identified as a result of the processing performed in 1008. If only one summary was identified, then at 1028 the subsystem 120 tags the single summary identified in 906 as the selected summary and the processing proceeds to block 1014 in FIG. 10A to output the selected summary. If more than one summary was identified in 1026, then at 1030, the subsystem 120 identifies a summary from the summaries that answers the largest number of good-to-have questions. At 1032, the subsystem 120 tags the single summary identified in 1030 as the selected summary and proceeds to perform the processing in block 1014 in FIG. 9A to output the selected summary.

The summary generation and summary selection system described above addresses several deficiencies of conventional approaches for evaluating multiple summaries to identify the “best” single summary. As previously described, conventional approaches for evaluating multiple summaries involve a lot of manual labor that involves manually inspecting the summaries to determine the “best” summary. The disclosed summary generation and summary selection system is capable of automatically evaluating multiple summaries generated for content and selecting a single summary that is deemed to be the “best” among the multiple generated summaries for the content. The system includes capabilities to use multiple different selection techniques as described above to select a summary from multiple generated summaries. Each summary selection technique evaluates the multiple summaries using selection criteria for that technique and selects a summary that is the “best” based upon the technique's selection criteria.

### Example Cloud Service Infrastructure Architecture

Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

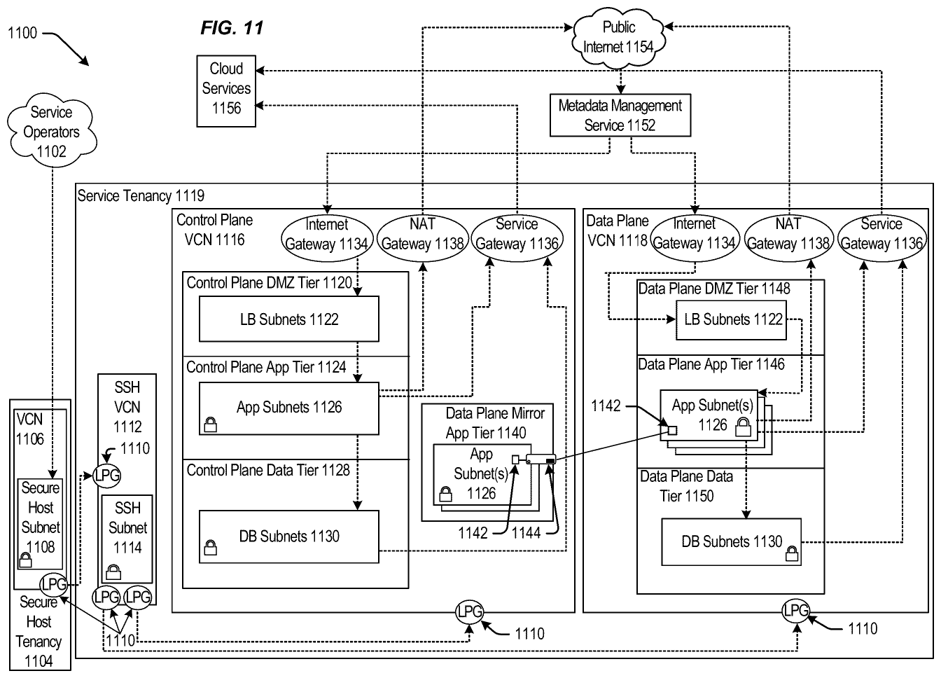

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively couple to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

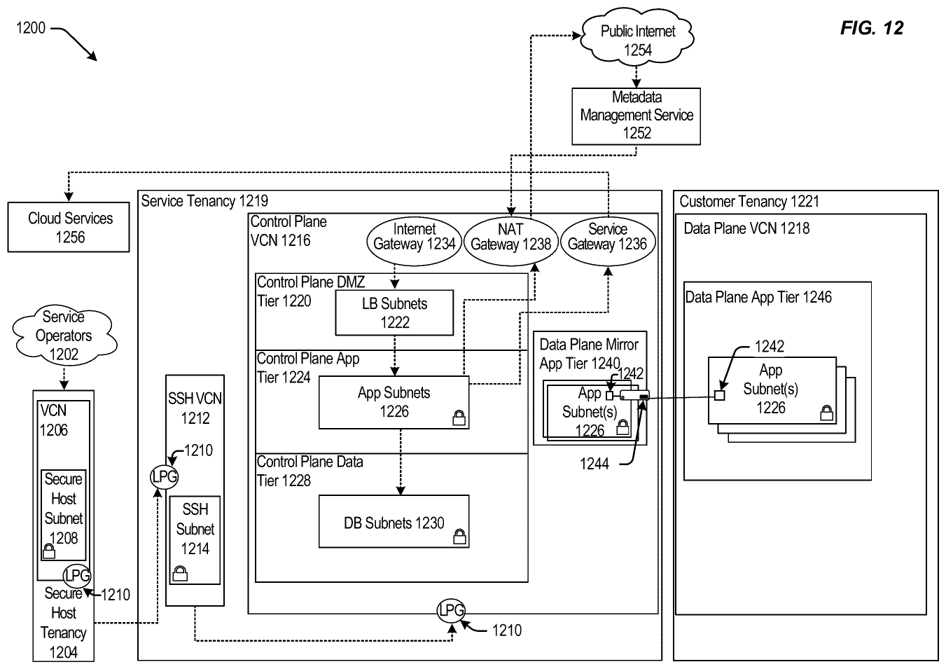

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively couple to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

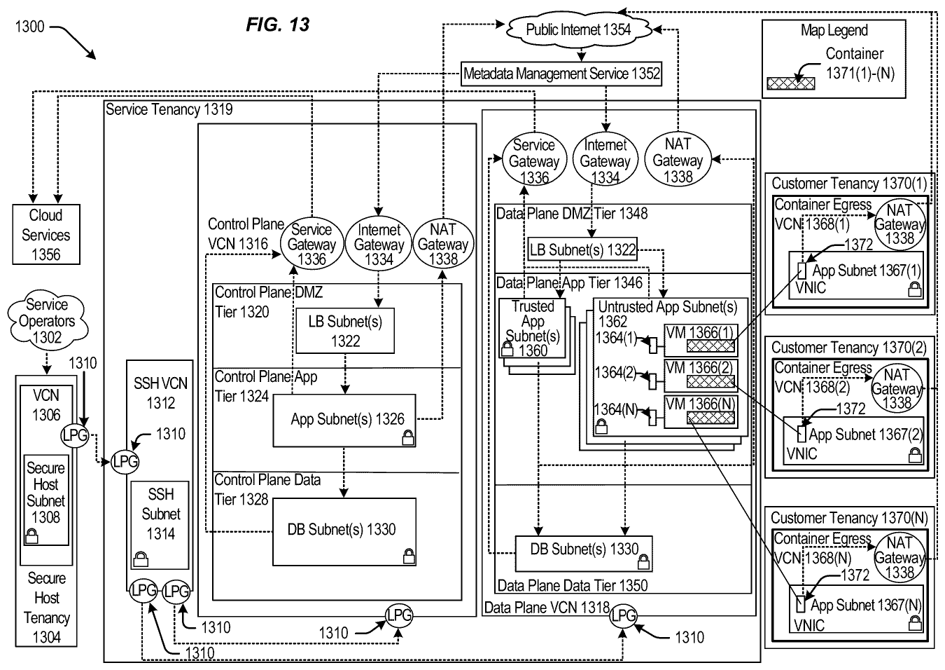

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

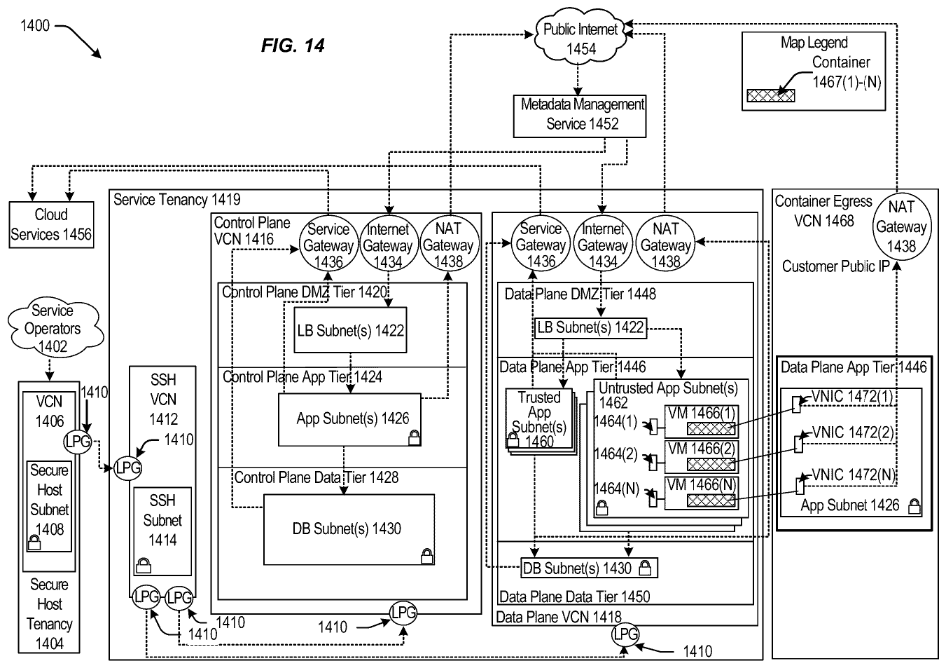

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

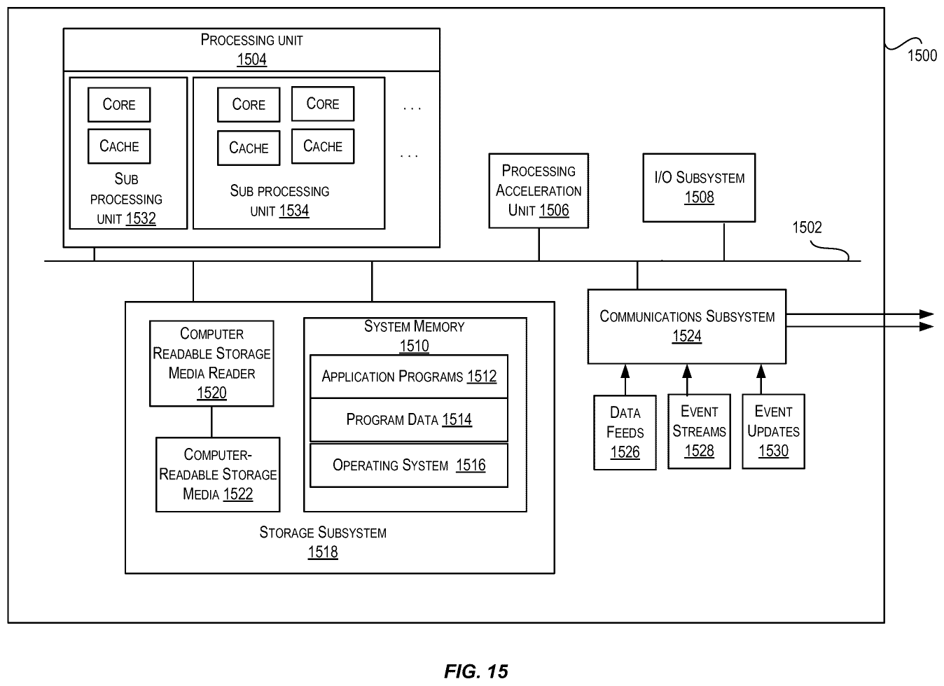

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that comprises software elements, shown as being currently located within a system memory 1510. System memory 1510 may store program instructions that are loadable and executable on processing unit 1504, as well as data generated during the execution of these programs.

Depending on the configuration and type of computer system 1500, system memory 1510 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1504. In some implementations, system memory 1510 may include multiple different types of memory, such as static random access memory (SRAM) or dynamic random access memory (DRAM). In some implementations, a basic input/output system (BIOS), containing the basic routines that help to transfer information between elements within computer system 1500, such as during start-up, may typically be stored in the ROM. By way of example, and not limitation, system memory 1510 also illustrates application programs 1512, which may include client applications, Web browsers, mid-tier applications, relational database management systems (RDBMS), etc., program data 1514, and an operating system 1516. By way of example, operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1518 may also provide a tangible computer-readable storage medium for storing the basic programming and data constructs that provide the functionality of some embodiments. Software (programs, code modules, instructions) that when executed by a processor provide the functionality described above may be stored in storage subsystem 1518. These software modules or instructions may be executed by processing unit 1504. Storage subsystem 1518 may also provide a repository for storing data used in accordance with the present disclosure.

Storage subsystem 1500 may also include a computer-readable storage media reader 1520 that can further be connected to computer-readable storage media 1522. Together and, optionally, in combination with system memory 1510, computer-readable storage media 1522 may comprehensively represent remote, local, fixed, and/or removable storage devices plus storage media for temporarily and/or more permanently containing, storing, transmitting, and retrieving computer-readable information.

Computer-readable storage media 1522 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1500.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1500.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
identifying, by a summary selection system and based upon a plurality of prioritized entity categories identified in reference information, a set of prioritized entities present in content to be summarized and corresponding to one or more prioritized entity categories from the plurality of prioritized entity categories, the summary selection system comprising one or more computer systems;
identifying, by the summary selection system and based upon a plurality of prioritized entity relationship categories identified in the reference information, a set of prioritized entity relationships present in the content to be summarized and corresponding to one or more prioritized entity relationship categories from the plurality of prioritized entity relationship categories;
selecting, by the summary selection system and from a plurality of summaries generated for the content to be summarized, a summary that includes each entity in the set of prioritized entities and each entity relationship in the set of prioritized entity relationships; and
providing, by the summary selection system, the selected summary as a summary for the content to be summarized.

2. The method of claim 1, wherein the plurality of summaries for the content to be summarized are generated using a machine learning (ML) model and a plurality of input parameters.

3. The method of claim 2, wherein the input parameters comprise one or more of: a prompt provided to the ML model, a summarization strategy used by the ML model to generate the plurality of summaries, and a temperature setting used by the ML model to generate the plurality of summaries.

4. The method of claim 1, wherein selecting the summary from the plurality of summaries comprises:
generating, by the summary selection system, a plurality of clusters, wherein each cluster in the plurality of clusters comprises one or more summaries from the plurality of summaries;
selecting, by the summary selection system, a cluster from the plurality of clusters that comprises the largest number of summaries;
processing, by the summary selection system, the one or more summaries from the plurality of summaries present in the selected cluster; and
based on the processing, selecting, by the summary selection system, a summary from the one or more summaries present in the selected cluster as the summary for the content to be summarized.

5. The method of claim 4, wherein generating, by the summary selection system, the plurality of clusters comprises:
extracting, for each summary in the plurality of summaries, a set of unigrams and a set of bigrams for the summary;
generating a vocabulary comprising a union of the set of unigrams and the set of bigrams extracted from the plurality of summaries; and
generating, for each summary in the plurality of summaries, an incidence vector for the summary, wherein the incidence vector represents the set of unigrams and the set of bigrams from the vocabulary that are present in the summary.

6. The method of claim 5, further comprising using, by the summary selection system, a clustering technique to cluster the plurality of summaries using the incidence vectors generated for each summary in the plurality of summaries to generate the plurality of clusters.

7. The method of claim 4, wherein processing, by the summary selection system, the one or more summaries from the plurality of summaries present in the selected cluster comprises:
for each summary in the one or more summaries in the selected cluster, extracting one or more entities from the summary;
for each summary in the one or more summaries in the selected cluster, extracting one or more entity relationships from the summary;
identifying a summary from the one or more summaries in the selected cluster that includes each entity in the set of prioritized entities and each entity relationship in the set of prioritized entity relationships present in the content to be summarized; and
selecting the summary as the summary for the content to be summarized.

8. The method of claim 7, wherein the processing further comprises:
determining that no summary in the one or more summaries in the selected cluster includes each entity in the set of prioritized entities and each entity relationship in the set of prioritized entity relationships present in the content to be summarized;
based on the determining, selecting a new cluster from the plurality of clusters that comprises the largest number of summaries for processing;
processing one or more summaries from the plurality of summaries present in the new cluster; and
based on the processing, selecting, by the summary selection system, a summary from the one or more summaries present in the new cluster as the summary for the content to be summarized.

9. The method of claim 7, wherein the processing further comprises:
determining that more than one summary in the one or more summaries in the selected cluster includes each entity in the set of prioritized entities and each entity relationship in the set of prioritized entity relationships present in the content to be summarized;
responsive to the determining, identifying, for each summary, one or more good-to-have entities and one or more good-to-have relationships present in the summary; and
selecting a summary that has the largest number of good-to-have entities and the largest number of good-to-have relationships as the summary for the content to be summarized.

10. The method of claim 9, wherein the one or more good-to-have entities and the one or more good-to-have entity relationships are identified in the summary based upon identifying a set of good-to-have entities and a set of good-to-have relationships in content to be summarized.

11. A method comprising:
for each summary in a plurality of summaries generated for content to be summarized, determining, from a plurality of prioritized questions identified in a reference set of questions, a set of prioritized questions that are answered by the summary;
selecting, by a summary selection system, a summary from the plurality of summaries based upon the set of prioritized questions that are answered by each summary in the plurality of summaries, the summary selection system comprising one or more computer systems; and
providing, by the summary selection system, the summary as the summary for the content to be summarized.

12. The method of claim 11, wherein determining the set of prioritized questions that are answered by each summary comprises:
determining, by the summary selection system, that at least one summary from the plurality of summaries answers each prioritized question in the reference set of questions;
responsive to determining that at least one summary from the plurality of summaries answers each prioritized question in the reference set of questions, selecting, by the summary selection system, a summary from one or more summaries in the plurality of summaries that answers each prioritized question in the reference set of questions; and
providing, by the summary selection system, the summary as the summary for the content to be summarized.

13. The method of claim 12, wherein determining that at least one summary from the plurality of summaries answers each prioritized question in the reference set of questions comprises:
determining, by the summary selection system, that a single summary in the plurality of summaries answers each prioritized question in the reference set of questions; and
responsive to the determining, selecting, by the summary selection system, the single summary as the summary for the content to be summarized.

14. The method of claim 12, wherein determining that at least one summary from the plurality of summaries answers each prioritized question in the reference set of questions comprises:
determining, by the summary selection system, that one or more summaries in the plurality of summaries answers each prioritized question in the reference set of questions.

15. The method of claim 14, further comprising:
for each summary from the one or more summaries, determining, by the summary selection system, from a plurality of good-to-answer questions identified in the reference set of questions, a set of good-to-answer questions that are answered by the summary;
selecting, by the summary selection system, the summary from the one or more summaries that answers the greatest number of good-to-have questions; and
providing, by the summary selection system, the summary as the summary for the content to be summarized.

16. The method of claim 11, further comprising:
determining, by the summary selection system, that no summary in the plurality of summaries answers each prioritized question in the reference set of questions;
responsive to the determining, determining, by the summary selection system whether a summary generation threshold is met; and
responsive to determining that the summary generation threshold is not met, generating, by the summary selection system, a new set of multiple summaries for the content to be summarized.

17. The method of claim 16, further comprising:
responsive to determining that the summary generation threshold is met, identifying, by the summary selection system, a single summary from the plurality of summaries answers the largest number of prioritized questions in the reference set of questions; and
selecting, by the summary selection system, the single summary as the summary for the content to be summarized.

18. The method of claim 16, further comprising:
responsive to determining that the summary generation threshold is met, identifying, by the summary selection system, one or more summaries from the plurality of summaries answers the largest number of prioritized questions in the reference set of questions; and
for each summary from the one or more summaries, determining, by the summary selection system, from a plurality of good-to-answer questions identified in the reference set of questions, a set of good-to-answer questions that are answered by the summary.

19. The method of claim 18 further comprising:
selecting, by the summary selection system, the summary from the one or more summaries that answers the largest number of good-to-have questions; and
providing, by the summary selection system, the summary as the summary for the content to be summarized.

20. The method of claim 11 wherein the content to be summarized represents a hospital note and the plurality of summaries represent a plurality of hospital discharge summaries.

21. One or more non-transitory computer-readable media storing instructions executable by a computer system that, when executed by one or more processors of the computer system, cause the computer system to perform operations comprising:
identifying, based upon a plurality of prioritized entity categories identified in reference information, a set of prioritized entities present in content to be summarized and corresponding to one or more prioritized entity categories from the plurality of prioritized entity categories;
identifying based upon a plurality of prioritized entity relationship categories identified in the reference information, a set of prioritized entity relationships present in the content to be summarized and corresponding to one or more prioritized entity relationship categories from the plurality of prioritized entity relationship categories;
selecting from a plurality of summaries generated for the content to be summarized, a summary that includes each entity in the set of prioritized entities and each entity relationship in the set of prioritized entity relationships; and
providing the selected summary as a summary for the content to be summarized.

22. The non-transitory computer-readable medium of claim 21, wherein the plurality of summaries for the content to be summarized are generated using a machine learning (ML) model and a plurality of input parameters.

23. The non-transitory computer-readable medium of claim 22, wherein the input parameters comprise one or more of: a prompt provided to the ML model, a summarization strategy used by the ML model to generate the plurality of summaries, and a temperature setting used by the ML model to generate the plurality of summaries.

24. The non-transitory computer-readable medium of claim 21, wherein selecting the summary from the plurality of summaries comprises:
generating a plurality of clusters, wherein each cluster in the plurality of clusters comprises one or more summaries from the plurality of summaries;
selecting a cluster from the plurality of clusters that comprises the largest number of summaries;
processing the one or more summaries from the plurality of summaries present in the selected cluster; and
based on the processing, selecting a summary from the one or more summaries present in the selected cluster as the summary for the content to be summarized.

25. The non-transitory computer-readable medium of claim 24, wherein generating the plurality of clusters comprises:
extracting, for each summary in the plurality of summaries, a set of unigrams and a set of bigrams for the summary;
generating a vocabulary comprising a union of the set of unigrams and the set of bigrams extracted from the plurality of summaries; and
generating, for each summary in the plurality of summaries, an incidence vector for the summary, wherein the incidence vector represents the set of unigrams and the set of bigrams from the vocabulary that are present in the summary.

26. One or more non-transitory computer-readable media storing instructions executable by a computer system that, when executed by one or more processors of the computer system, cause the computer system to perform operations comprising:
for each summary in a plurality of summaries generated for content to be summarized, determining, from a plurality of prioritized questions identified in a reference set of questions, a set of prioritized questions that are answered by the summary;
selecting a particular summary from the plurality of summaries based upon the set of prioritized questions that are answered by each summary in the plurality of summaries; and
providing the particular summary as the summary for the content to be summarized.

27. The non-transitory computer-readable medium of claim 26, wherein determining the set of prioritized questions that are answered by each summary comprises:
determining that at least one summary from the plurality of summaries answers each prioritized question in the reference set of questions;
responsive to determining that at least one summary from the plurality of summaries answers each prioritized question in the reference set of questions, selecting a summary from one or more summaries in the plurality of summaries that answers each prioritized question in the reference set of questions; and
providing the summary as the summary for the content to be summarized.

28. The non-transitory computer-readable medium of claim 27, wherein determining that at least one summary answers each prioritized question in the reference set of questions comprises:
determining that a single summary in the plurality of summaries answers each prioritized question in the reference set of questions; and
responsive to the determining, selecting the single summary as the summary for the content to be summarized.

29. The non-transitory computer-readable medium of claim 27, wherein determining that at least one summary answers each prioritized question in the reference set of questions comprises: determining, by the summary selection system that one or more summaries in the plurality of summaries answers each must-answer question in the reference set of questions.

30. The non-transitory computer-readable medium of claim 29 further comprising:
for each summary from the one or more summaries, determining, from a plurality of good-to-answer questions identified in the reference set of questions, a set of good-to-answer questions that are answered by the summary;
selecting the summary from the one or more summaries that answers the greatest number of good-to-have questions; and
providing the summary as the summary for the content to be summarized.
